(19) United States
(12) Patent Application Publication
(10) Pub. No.: US 2015/0019486 A1
(43) Pub. Date: Jan. 15, 2015

(54) System and Method for Delta Change Synchronization of Data Changes across a Plurality of Nodes

(71) Applicant: Zensar Technologies Ltd., Pune (IN)

(72) Inventors: Vijaykumar Vasantrao Gaikwad, Pune (IN); Saurabh Manohar Bobde, Pune (IN)

(21) Appl. No.: 14/340,036

(22) Filed: Jul. 24, 2014

Related U.S. Application Data
(63) Continuation-in-part of application No. 13/097,522, filed on Apr. 29, 2011, now abandoned.

(30) Foreign Application Priority Data
Nov. 18, 2010 (IN) 3148/MUM/2010

(51) Int. Cl. G06F 17/30; H04L 29/06

(52) U.S. Cl. CPC G06F 17/30575; H04L 67/42
USPC 707/625

(57) ABSTRACT

A system and method for delta change synchronization of data changes across a plurality of nodes such as in a collaboration system have been disclosed. The system performs delta change synchronization by generating an initial model comprising objects corresponding to content, transferring initial model between two or multiple nodes and further by rendering only the changed objects of the model-to-model architecture. A tool is provided which is resident on all the nodes participating in a session. This tool comprises a delta change processing sub-system which mainly includes a delta change recorder for recording delta changes corresponding to the changes in the objects of the initial model and rendering the delta changes to other nodes in order to achieve synchronization.

### BACKGROUND OF THE INVENTION

1. Field of the Invention

The present disclosure relates to the field of communication of data corresponding to content across a plurality of nodes.

Particularly, the disclosure relates to synchronization of changes to data corresponding to content across a plurality of nodes.

2. Description of the Background Art

Modeling technology in the software/Information Technology domain uses data structures and graphical representation of “model and display” symbols, which give meaning to model representation along with profile description specifying necessary details about the model to allow individual model elements of the similar type to be represented uniquely. Such models can be represented by abstract data types: for instance Link lists, Stacks, and Tree structures.

During the creation, dissemination of content or review of content it is often that these processes are of a collaborative nature and are carried out at a plurality of nodes which may be remotely located. These processes generally require the data to be shared and changed on the fly. Such content and particularly changes in the data corresponding to the content can be represented on a computer's (sender and originator or master computer) display (LCD and other variants) in typical pixel format and can be shared within the group of plurality of nodes with a suitable utility program through LAN/WAN or similar networks with suitable screen rendering systems; for instance Net meeting, WebEx and the like. But, in the case of networks where these nodes are remotely located and when communication is desired over large distances optimal performance is not attained.

The amount of data transferred for every change in the source screen remains large as it is pixel-information for the full screen and ends up requiring higher bandwidth to keep reasonable response time for update or in the case of limited bandwidth slows down update on the receiver side node to a large extent thereby reducing real-time sync. This is a serious issue in communication across geographically distributed systems.

All the available techniques and systems mainly focus on transferring the screen data as image and video either as it is or after compression. For instance, United States Patent application 200410042547 discloses a method and apparatus for digitizing and compressing video signals for transmitting the signals between a remotely located computer and a host or local computer. The digitization and compression is done by dividing frame buffers into cells and comparing image data from previously captured frame buffers to create synchronized video signals and transmit the video signals over an extended range by limiting the portions of the transmission bandwidth of pixel data transferred between the remote computer and the local computer.

Another United States Patent Application 20090138808 discloses a method and apparatus for providing attributes of a collaboration system in an operating system folder-based file system. The disclosed apparatus allows synchronization of each folder or directory within the system wherein the folder/directory can be and is treated as a workspace that can be viewed and shared with other users or groups of users. In one embodiment, the system is a peer-to-peer system which allows direct communication between the collaborating computers and in another embodiment the system can be a client-server model. In such a system the server centrally maintains all the data. Moreover, the application does not envisage real-time updating/synchronization.

Thus, there is felt a need for a system which:

transfers and efficiently synchronizes only required changes to information of any artefact such as an image, document, application, and files across a plurality of nodes collaborating with each other;

which is not limited to transfer of the image or video signals for remote screen sharing;

can reduce the size of the data to be transferred during remote collaboration;

can provide real time or near real time updates on the receiver's machine; and

is time efficient, cost efficient and space efficient.

### SUMMARY OF THE INVENTION

Some of the non-limiting objects of the present disclosure include the following:

An object of the present disclosure is to provide a system and method which transfers and synchronizes changes to information of any artefact such as a document, image, application, system application, and files to a remote node.

One more object of the present disclosure is to provide a system and method which is not limited to transfer of the image or video signals for remote screen sharing.

Yet another object of the present disclosure is to provide a system and method which can reduce the size of the data to be transferred in a collaboration system comprising a plurality of remotely located nodes.

Still another object of the present disclosure is to provide a system and method which can provide real time or near real time updates on the receiver's node.

One more object of the present disclosure is to provide a time efficient, cost efficient and space efficient system and method for synchronizing changes to data corresponding to content within a network containing a plurality of collaborating nodes.

Other objects and advantages of the present disclosure will be more apparent from the following description when read in conjunction with the accompanying figures, which are not intended to limit the scope of the present disclosure.

The present disclosure envisages a system for delta change synchronization of changes to data corresponding to content in a network containing a plurality of nodes, wherein the system comprises a server. The server includes a session collaborator configured to establish, maintain and manage model-to-model collaboration sessions with the plurality of nodes via a network. The server also includes an authenticator configured to authenticate the identity of the plurality of nodes collaborating in a session.

The system for delta change synchronization also comprises a tool that is resident on each of the nodes collaborating in a session. This tool comprising a model generator adapted to generate, at the initiation of the collaboration session at a node acting as a host node, initial model comprising objects associated with content.

The tool also comprises a model handler co-operating with a transceiver of each node to transmit and receive information related to the generated initial model and its objects to and from the remaining nodes collaborating in a session. A content reproducer present in the tool and resident in the nodes is adapted to co-operate with the model handler to receive said information related to the initial model and its objects and reproduce said information in a receiving node.

The system further comprises a delta change processing sub-system comprising a delta change recorder adapted to record in a node acting as a host node, delta changes to the content. The delta change processing sub-system also comprises a delta change renderer configured, at a host node, to co-operate with the delta change recorder and receive the recorded delta changes and transmit the received recorded delta changes to the other nodes collaborating in the session, and, configured, at a client node, to receive the transmitted recorded delta changes. A delta change modifier present in the delta change processing sub-system is configured, at the client nodes to co-operate with the delta change renderer, receive the recorded delta changes and modify the model resident on the client nodes by applying the delta changes on the model on at least one of the client nodes.

The present disclosure envisages a computer implemented method for synchronization of changes to data corresponding to content in a network containing a plurality of nodes. The method, in accordance with the present disclosure comprises:
establishing, maintaining and managing model-to-model collaboration sessions with said plurality of nodes via a network;
authenticating the identity of said plurality of nodes collaborating in a session;
generating, at the initiation of the collaboration session at a node acting as a host node, initial models comprising objects associated with content;
transmitting information related to said generated initial model and its objects to the remaining nodes collaborating in a session;
receiving said information related to the initial model and its objects, and reproducing said information in a receiving node;
recording in a node acting as a host node, delta changes and transmitting the recorded delta changes to the remaining nodes collaborating in a session;
receiving the transmitted recorded delta changes on a client node; and
modifying the model resident on the client nodes by applying said delta changes on the model on at least one of the client nodes.

### BRIEF DESCRIPTION OF THE DRAWINGS

The disclosure will now be described with the help of accompanying drawings, in which:

FIG. 1 illustrates a system for delta change synchronization in accordance with the present disclosure.

FIG. 2 illustrates initiation of connection between host node and the client node in accordance with the present disclosure.

FIG. 3 illustrates establishment of a direct connection between host and the client in accordance with the present disclosure.

FIG. 4 illustrates initial model rendering from the host node to the client node in accordance with the present disclosure.

FIG. 5 illustrates the changes in the model occurring at host node in accordance with the present disclosure.

FIG. 6 illustrates the delta change rendering from the host node and client node in accordance with the present disclosure.

FIG. 7 illustrates the use of system for delta change synchronization between multiple nodes in accordance with the present disclosure.

FIG. 8 illustrates the flow diagram of the method for delta change synchronization in accordance with the present disclosure.

FIG. 9 illustrates the state flow diagram for delta change synchronization when change in the model has occurred immediately after rendering the initial model in accordance with the present disclosure.

### DETAILED DESCRIPTION

The term “object” used in the specification refers to an organized data structure of simple or complex data types corresponding to attributes of content including the content itself.

The term “model” used in the specification refers to a collection of object(s) corresponding to specified content. The “model” is realized as a data structure comprising properties or attributes of relevance.

The term “content” used in the specification refers to information contained within an artefact. An artefact in this sense can be a document file, a system file, an application, a system program, an image, a design, etc.

The term “delta change” used in the specification refers to the difference (change) in values of content on creation of new content, modification of existing content and/or deletion of existing content. It is a primary basis/construct using which synchronization of changes to data corresponding to content is processed vis-à-vis synchronizing the data in entirety.

These definitions are in addition to those expressed in the art.

The drawings and the description thereto are merely illustrative of a system for delta change synchronization of changes to data or content amongst a distributed plurality of nodes and only exemplify the disclosure and in no way limit the scope thereof.

The disclosure proposes a system and method for performing synchronization of changes to data corresponding to content by transferring between two or plurality of nodes, only the changed objects or entities in a model-to-model architecture, by recording a change to the content as a delta change as opposed to finding the difference between two models or objects, once a change has occurred.

Considering an example, in a typical file sharing system (for example a standard operating system like Microsoft Windows or Linux), a host user initially shares a folder containing a plurality of content comprising files, documents, images and the like. A user wanting to access this shared content, tries connecting over a network, and once connected the user is able to view the folder and its contents. Generally, in this method, the meta information about the content viz. document name, type, size, last modified, etc. is displayed first. Thus, when a host user wants to modify the content (e.g. a file's contents in the folder), the file must first be opened using a specific application (e.g. Photoshop for a .jpeg image file), and, then modify it. Further, if the host user modifies the opened file, the same is not visible to the other user, until the modifications are saved or the file is closed. Once the modification(s) are saved or the file closed, typically, an event/state is created which is used to trigger a ‘refresh’ of the meta information in the file sharing system on the other user's system. (For example, if a file “fABC.doc” is part of the shared folder, and it is modified, the user will see “fABC.doc and its meta information updated, but not the actual contents that have been modified by the host user.) Therefore, such sharing mechanisms do not allow the user to share the content while it is being viewed /modified. Additionally, if the user wishes to access the content, the entire content needs to be copied /transferred to the user, from the host user.

In a case where entire content needs to be copied /transferred, the data transfer involved between the host and the user/client is usually of higher volumes/sizes of the order of tens/hundreds of kilobytes. For example, if a file being shared and modified is a JPEG image, of size 300KB and a user/host changes the color of eyes of a person in the JPEG image, the “size” of such a change is of the order of a few tens of bytes (for e.g. 1000 bytes), as this change relates to a small set of pixels in the JPEG. The host/user makes the change, and saves the modified image file on the host having increased file size of 301KB. Now, when the connected participants want to view these changes, they have to receive (download) the modified image file on their machine, which requires transferring 301KB of data between the host and the user. As it can be observed in this example, a larger volume of data has to be exchanged between the host and clients that even though the change is a small (1KB in this example). This invariably results in increased network traffic, and additional processing on the sender/host and receiver/client sides. Further, due to this, in case of network congestion, or a larger number of connected clients, the rate of transmission of such information is impacted, and a compensation mechanism to counter any slowness and/or errors in transmission has to be incorporated.

The aforementioned technique/approach of file sharing is also applicable in case of screen-sharing based mechanisms, such as WebEx, wherein, the data to be transferred corresponds to the displayed screen information on the host. Such information, corresponding to each pixel of displayed information, is of the order of hundreds of kilobytes or greater. In order to reflect changes/updates to the displayed information on the host and client sides, the entire screen data has to be transmitted and refreshed with each action (such as a mouse cursor movement, mouse click, etc.) on the host machine.

In order to limit the aforementioned drawbacks (considering the same example), the delta change synchronization system and method as envisaged in the present disclosure, transfers and applies on the client, only a maximum of 1000 Bytes of pixel change related data corresponding to only the change that has occurred. Besides reducing the volume of data to be transferred between a plurality of connected machines/users, the system of the present disclosure also eliminates the need for compressing, de-compressing and processing the larger number of bytes of information.

In accordance with the system of the present disclosure, the information that is shared, modified and/or deleted between the plurality of nodes, comprises objects which are organized data structures of simple or complex data types containing information of any artefact such as an image, document, application, or any file, and, a model is a collection of such objects containing attributes of the content.

Further, in accordance with the present disclosure, all the participants' nodes are provided with a delta change processing sub-system. The delta change processing sub-system performs the function of recording changes in the objects of the initial model and modifying the respective models of the other participants to synchronize the delta changes between the participants in the collaboration session.

At first, the model ‘M’, at the node wanting to become host node or the first node, is shared between all the participants and a copy of model ‘M’ is stored into the memory of all the remainder participant nodes i.e. other than the host or sender or first node.

Further, changes in the model ‘M’ at any of the participating nodes are recorded using the delta change processing sub-system and the objects within the models of the remainder of the participant nodes are modified to synchronize these changes.

The delta change recorder available with the delta change processing sub-system basically performs the function of delta change recording in the objects contained within the model. These changes in the objects can occur due to certain events, for e.g. click event, key stroke event and the like.

In one embodiment, on collaboration, in case the model and objects correspond to display information (for example, if the model being modified corresponds to an image object/file), a modifier communicates with the GUI or any other Interface governing the display information to display the changes. However, in another embodiment, the model changes corresponding to the object will be recorded, transmitted and modified on the client node, to be processed suitably by any application on the client node.

The communication between participants of a session is routed through a server. In one embodiment, this server is remotely located from the participating nodes. In another embodiment, the server is resident on the participating nodes.

In accordance with the present disclosure, the participating nodes form a sender-receivers architecture or host-clients architecture.

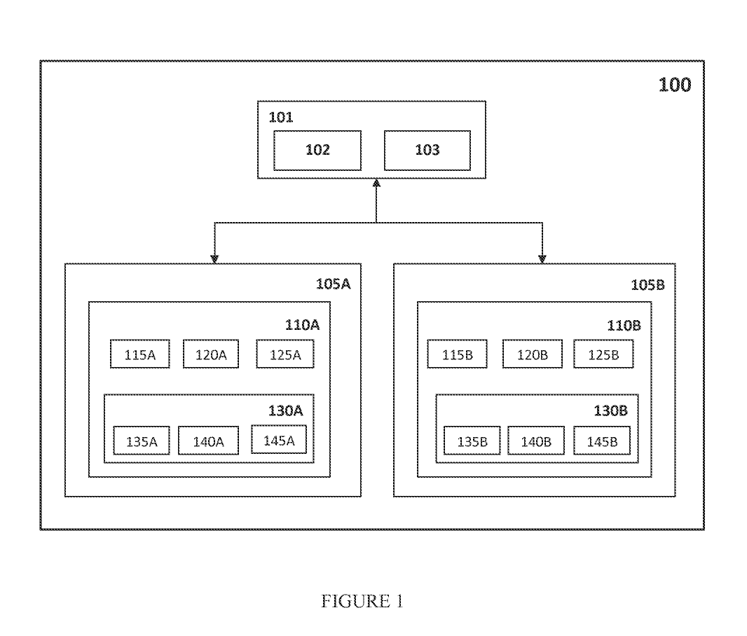

Referring to FIG. 1 there is shown a system 100 for Delta Change synchronization. The system includes a plurality of nodes (including 105A and 105B) which can be computers, laptops, mobile phones, iPADs, iPODs, and the like. These nodes are interconnected in a network which can be LAN, MAN, WAN, and the like. Further, the nodes communicate with each other and a server 101 using GPRS, Internet, 3G, Wifi, Satellite network and the like.

The server 101 can be remotely located or can be resident on the nodes. In one embodiment the server 101 can be a standalone dedicated physical server or it can be a virtual server. The server 101 establishes, maintains and manages model-to-model collaboration sessions between the plurality of nodes via a network with the help of a session collaborator 102. The server also comprises an authenticator 103 that authenticates the identity of the plurality of nodes collaborating in a session.

For clarity and convenience the disclosure will now be explained using two nodes referred by 105A and 105B where the node 105A is a first/sender/host node and the node 105B is a receiver/client node. However, it should be clearly understood by any person skilled in art that there can be a plurality of nodes connected together.

In accordance with the present disclosure, the session collaborator 102 establishes, maintains and manages collaboration session between the host node 105A and the client node 105B after authentication of the nodes by the authenticator 103. Tools 110A and 110B are respectively resident on the nodes 105A and 105B collaborating in the session. Both the tools 110A and 110B resident on the nodes 105A and 105B include model generators 115A and 115B respectively to generate models corresponding to the content (to be collaborated upon) on the participating nodes. However, the node 105A being the sender/host node, generates, on initiation of the collaboration session, an initial model comprising objects associated with content available at the node 105A.

In accordance with the present disclosure, the content can correspond to documents, images, videos, system programs application programs, application files, their combinations and the like.

Further, the tools 110A and 110B include model handlers 120A and 120B on the nodes 105A and 105B respectively. The model handlers 120A and 120B co-operate with transceivers (not shown in the figure) to transmit and receive information related to the generated initial model along with its objects, from the nodes in the collaboration session. The tools 110A and 110B on nodes 105A and 105B include content reproducers 125A and 125B respectively. The content reproducer 125B available with the receiver/client node 105B, co-operates with the model handler 120B to receive the information related to the initial model as transmitted by the model handler 120A of the sender/host node 105A, and, reproduces the information in the receiver/client node 105B.

The tools 110A and 110B on the nodes 105A and 105B also include delta change processing sub-systems 130A and 130B respectively. The delta change processing sub-systems are used for recording the changes in the models at the sender/host node and for synchronizing the changes to the receiver/client node(s). The delta change processing sub-systems 130A and 130B includes delta change recorders 135A and 135B respectively. The delta change recorder 135A records the changes in objects of the model. For instance, in case of an occurrence of an event like a click event, scroll event, stroke event, drag event, text select event, text edit/key press event, their combinations or any changes occurring due to activities, performed by a node, the delta change recorder 135A will synchronously record the changes that occur in the object due to the events in order to modify the content corresponding to the object on the receiver/client node.

Further, a delta change renderer 140A and 140B is included in the tools 110A and 110B of the nodes 105A and 105B respectively. The delta change renderer 140A available with the tool 110A of the first/sender/host node 105A, co-operates with the delta change recorder 135A to receive the recorded delta changes, and, transmits these delta changes to the delta change renderer 140B on the tool 110B of the receiver/client node 105B.

The tools 110A and 110B of the nodes 105A and 105B are provided with modifiers 145A and 145B respectively. The modifier 145B available with the tool 110B of the receiver node 105B co-operates with the delta change renderer 140B to receive the recorded delta changes and, modifies the model on the receiver/client node 105B by applying the delta changes on the model on the client node 105B.

In one embodiment of the present disclosure, the session collaborator 102 records, during the session, a chronology of delta changes. This gives the participating nodes, capability of automatically receiving and synchronizing the delta changes in case the nodes go offline for a limited duration during the session.

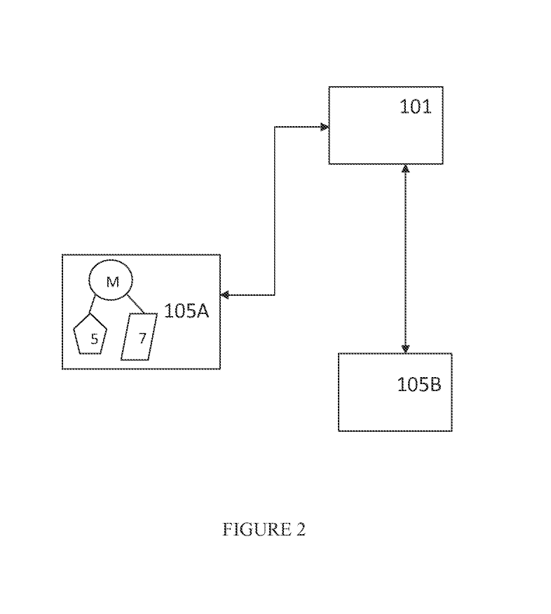

Referring to FIG. 2 there is shown initiation of connection between a first/host node 105A and the receiver/client node 105B where both the nodes connect to a server 101. Also, nodes are authenticated by providing session credentials, for instance, user name, passwords, graphic passwords and the like.

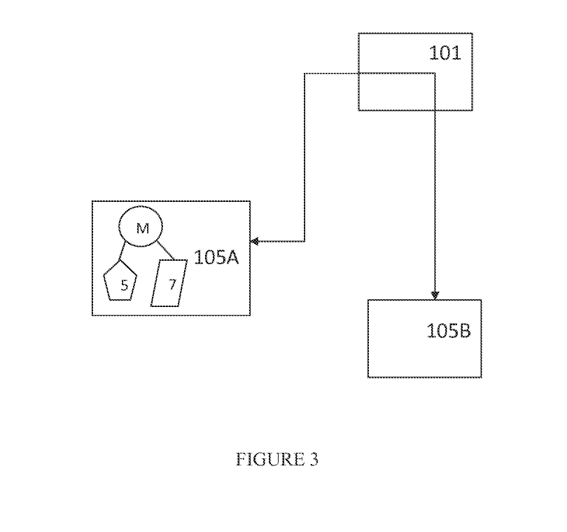

After authentication is done and both the nodes are connected to the server, a direct collaboration session is established between the nodes 105A and 105B as shown in FIG. 3.

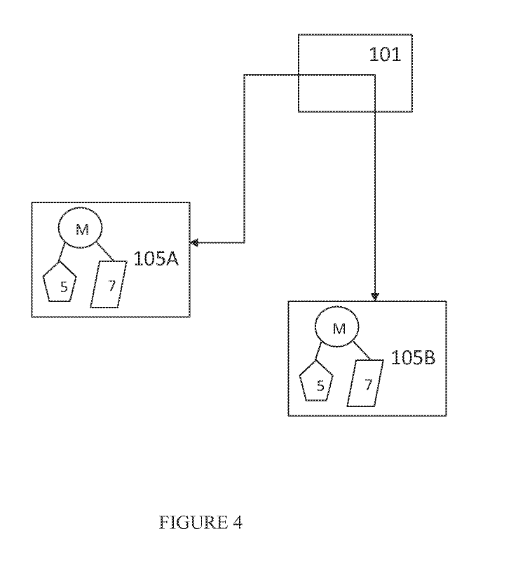

Further, initial model ‘M’ comprising objects 5, 7 at the first/host node 105A is sent to the client node 105B as shown in FIG. 4.

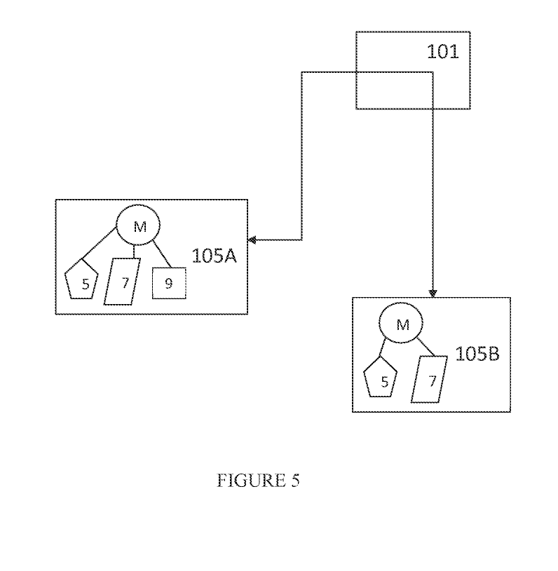

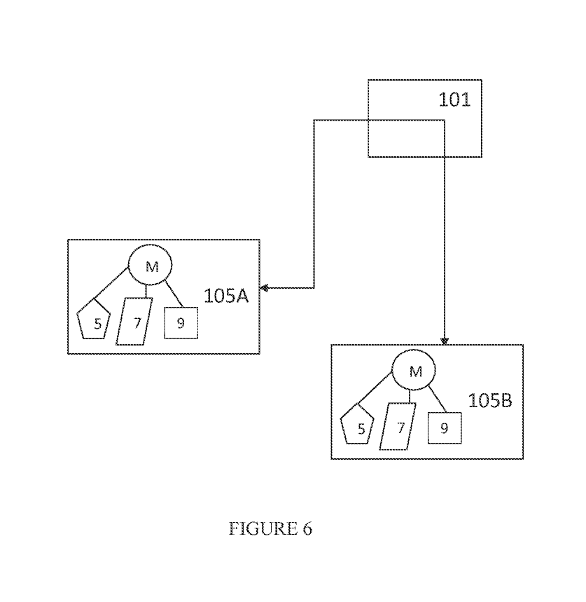

Still further, the changes in the model occurring at the host node are recorded i.e. in this example; initiation of a new object 9 is recorded at the host node 105A as shown in FIG. 5. The new object (vis-à-vis the model ‘M’) in the model represents the delta change (i.e. only the newly created object 9), this delta change is sent by the host node 105A to the client node 105B as shown in FIG. 6.

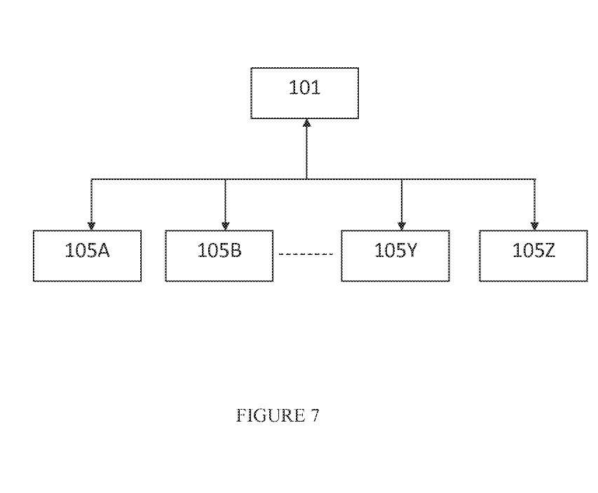

Referring to FIG. 7 there is shown the multiple node architecture in accordance with another aspect of the present disclosure where the multiple nodes 105A, 105B - - - 105Y, 105Z are simultaneously participating in a collaboration session. Any node can become the sender/first/host node by initiating a model or by synchronizing the changes in the model shared across multiple participants. However, at any instance of time any one node can be the first node or the sender node and remainder of nodes are the receiver nodes.

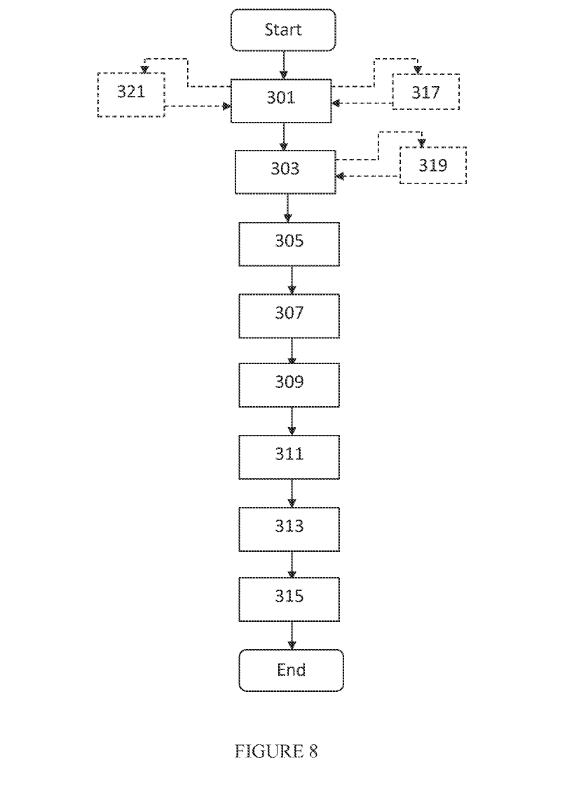

Referring to FIG. 8 there is shown a method for Delta Change synchronization, in accordance with the present disclosure. The method comprises the following steps:

establishing, maintaining and managing model-to-model collaboration sessions between the plurality of nodes via a network, 301;

authenticating the identity of said plurality of nodes collaborating in a session, 303;

generating, at the initiation of the collaboration session at a node acting as a host node, an initial model comprising objects associated with content, 305;

transmitting information related to said generated initial model and its objects to the remaining nodes collaborating in a session, 307;

receiving said information related to the initial model and its objects, and reproducing said information in a receiving node, 309;

recording in a node acting as a host node, delta changes and transmitting the recorded delta changes, 311;

receiving the transmitted recorded delta changes, 313;

modifying the model resident on the client nodes by applying, said delta changes on the model on at least one of the remainder of the client nodes, to synchronize said delta changes 315;

The step of establishing, maintaining and managing model-to-model collaboration sessions further includes step of maintaining during the session, chronology of delta changes, 317.

The step of authenticating further includes step of ensuring secure authentication of nodes by at least one way authentication, 319.

The step of establishing, maintaining and managing collaboration sessions also includes step of establishing, maintaining and managing object-to-object collaboration sessions, 321.

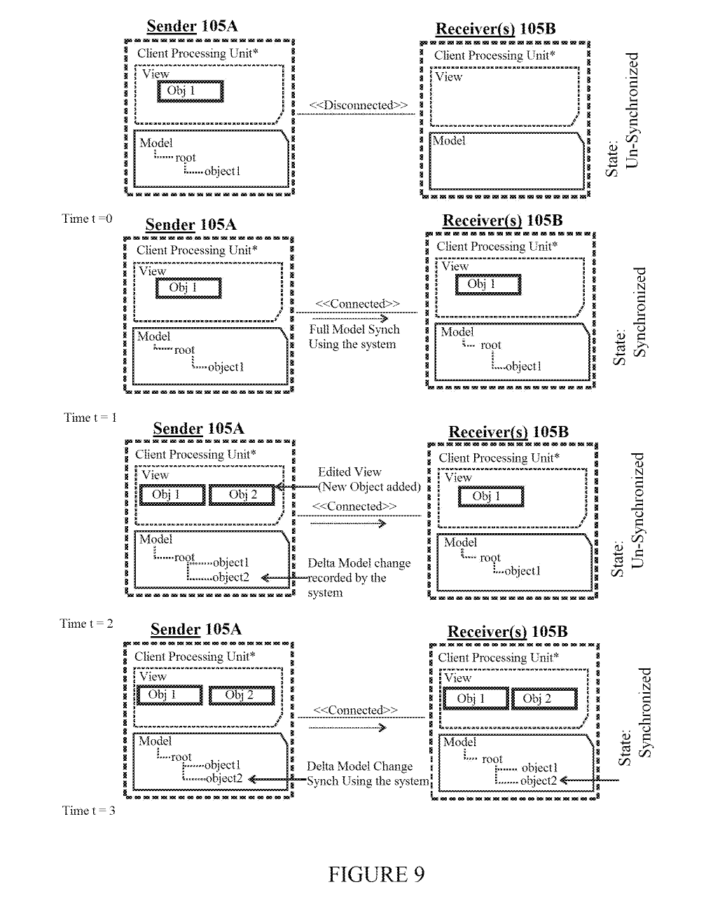

Referring to FIG. 9 there is illustrated the flow of the model containing objects between the nodes 105A and 105B at different instances of time.

The model “M” is generated at the first node 105A at a time period t=0, which, on establishing the collaboration session (i.e. in a synchronized state) is synchronized to the participant node 105B at a time period t=1; correspondingly the content corresponding to the object is visible to the user of participant node 105B.

Further, at time period t=2 the model at the first node 105A is changed due to change in the content [by a user or any other event] and a corresponding new object is created which is recorded by a delta change recorder as a delta change.

At time period t=3 the delta change as recorded by the delta change recorder is transmitted to synchronize the change to the participant node 105B. A modifier on the participating node 105B modifies the model, based on the received delta change, to synchronize the same corresponding to the model on host node 105A.

In accordance with an exemplary embodiment of the present disclosure there is illustrated working of the system for delta change synchronization for image modification.

A first node or the sender node creates a model for face modification application (i.e. application program) wherein the objects are the image of a human to be modified, and its attributes. For instance, these attributes can be the facial structure, color of eyes, hair style and the like. The first node then synchronizes the model to remainder of said plurality of nodes connected with said first node.

In one embodiment of the system of the present disclosure, any node can, on request to the session collaborator, attain the state of a host node.

Considering an example where a second node (acting as a host node) changes some of the attributes of the image, for example, adds a French beard, the change will cause corresponding changes in objects and the associated model. These changes in objects and the model are recorded by the delta change processing sub-system at the second node using a delta change recorder. The recorded changes are synchronously transmitted to at least one of the remainder of the connected nodes.

Further, the recorded delta changes are received and used by a modifier at the remainder of the connected nodes, to modify the models at the nodes to change and thus synchronize the image attribute to display a French beard on the image.

In accordance with one embodiment of the system of the present disclosure, the system provides mutli-delta change transmission, wherein, more than one node can act as host node(s) simultaneously.

Further, in accordance with another embodiment of the present disclosure, the system for delta change synchronization of the present disclosure is platform agnostic. In order to achieve this, the tools that are present on the plurality of nodes included in the system comprise an interface for multiple platforms. This interface is built to recognize the platform and perform delta change synchronization of data changes across multiple nodes of same or different platform.

The technical advantages of the present disclosure include providing:

a system and method which transfers and efficiently synchronizes changes to information corresponding to the content of any document, image, application, and files to a remote node;

a system and method which is not limited to transfer of the image or video signals for remote screen sharing;

a system and method which can reduce the size of the data to be transferred between devices in a collaboration system;

a system and method which can provide real time or near real time updates on the receiver's machine;

and a time efficient, cost efficient and space efficient system for synchronizing changes to data or content in a collaboration system.

While considerable emphasis has been placed herein on the particular features of this disclosure, it will be appreciated that various modifications can be made, and that many changes can be made in the preferred embodiment without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

We claim:

1. A system for delta change synchronization of changes to data corresponding to content in a network containing a plurality of nodes, said system comprising:
i. a server comprising:
a. a session collaborator configured to establish, maintain and manage model-to-model collaboration sessions between said plurality of nodes via a network; and
b. an authenticator configured to authenticate the identity of said plurality of nodes collaborating in a session;
ii. a tool, resident on each of the nodes collaborating in a session, said tool comprising:
a. a model generator adapted to generate, at the initiation of the collaboration session at a node acting as a host node, an initial model comprising objects associated with content;
b. a model handler co-operating with a transceiver within each node to transmit and receive information related to said generated initial model and its objects to and from the remaining nodes collaborating in a session;
c. a content reproducer resident in the nodes adapted to co-operate with said model handler to receive said information related to the initial model and its objects and reproduce said information in a receiving node; and
d. a delta change processing sub-system comprising:
a delta change recorder adapted to record in a node acting as a host node, delta changes;
a delta change renderer configured, at a host node, to co-operate with the delta change recorder and receive the recorded delta changes and transmit the received recorded delta changes to the other nodes collaborating in the session, and, configured, at a client node, to receive the transmitted recorded delta changes; and
a delta change modifier configured, at the client nodes to co-operate with said delta change renderer to receive said recorded delta changes and to modify the model resident on the client nodes by applying said delta changes on the model on at least one of the client nodes, to synchronize said delta changes on the model of the client nodes.

2. The system as claimed in claim 1, wherein said server is remotely located from said nodes.

3. The system as claimed in claim 1, wherein said server is resident on said client nodes.

4. The system as claimed in claim 1, wherein said session collaborator records, during the session, chronology of delta changes.

5. The system as claimed in claim 1, wherein said authenticator ensures secure authentication of nodes by at least one way authentication.

6. The system as claimed in claim 1, wherein said tool is platform agnostic and includes interfaces for different platforms.

7. The system as claimed in claim 1, wherein said session collaborator is configured to establish, maintain and manage object-to-object collaboration session within said model-to-model collaboration sessions.

8. A method for synchronization of changes to data corresponding to content in a network containing plurality of nodes, said method comprising the following steps:
establishing, maintaining and managing model-to-model collaboration sessions between said plurality of nodes via a network;
authenticating the identity of said plurality of nodes collaborating in a session;
generating, at the initiation of the collaboration session at a node acting as a host node, an initial model comprising objects associated with content;
transmitting information related to said generated initial model and its objects to the remaining nodes collaborating in a session;
receiving said information related to the initial model and its objects, and reproducing said information in a receiving node;
recording in a node acting as a host node, delta changes and transmitting the recorded delta changes;
receiving on a client node, the transmitted recorded delta changes; and
modifying the model resident on the client nodes by applying said delta changes on the model on at least one of the client nodes to synchronize the models and its objects between the host and client nodes.

9. The method as claimed in claim 8, wherein the step of establishing, maintaining and managing model-to-model collaboration sessions includes step of maintaining during the session, chronology of delta changes.

10. The method as claimed in claim 8, wherein the step of authenticating includes step of ensuring secure authentication of nodes by at least one way authentication.

11. The method as claimed in claim 8, wherein the step of establishing, maintaining and managing collaboration sessions includes step of establishing, maintaining and managing object-to-object collaboration sessions.
